(19) United States
(12) Patent Application Publication
(10) Pub. No.: US 2007/0198595 A1
(43) Pub. Date: Aug. 23, 2007

(54) Information processing apparatus, information processing method, and program

(75) Inventors: Hideo Obata, Kanagawa (JP); Shigeru Kashiwagi, Tokyo (JP); Masayoshi Ohno, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/646,188

(22) Filed: Dec. 27, 2006

(30) Foreign Application Priority Data
Dec. 28, 2005 (JP) P2005-379327

(51) Int. Cl. G06F 17/30

(52) U.S. Cl. 707/200

(57) ABSTRACT

An information processing apparatus includes a basic file manager that manages files stored on a storage medium using basic file management information stored on the storage medium; a specific file manager that manages a file of a specific type, among the managed files, using specific file management information stored on the storage medium as one of the files managed by the basic file manager; a reference-information manager that stores reference information relating to the specific file management information, the reference information having meanings corresponding to predetermined information items provided for each of the files and included in the basic file management information, and that updates the reference information in accordance with updating of the specific file management information; and a validity checker configured to check validity of the specific file management information by comparing the stored reference information with the information items having corresponding meanings in the basic file management information.

### CROSS-REFERENCE TO RELATED APPLICATIONS

The present application claims priority from Japanese Patent Application No. JP 2005-379327 filed on Dec. 28, 2005, the disclosure of which is hereby incorporated by reference herein.

### BACKGROUND OF THE INVENTION

1. Field of the Invention

The present invention relates to information processing methods and apparatuses for writing information to or reading information from storage media. The present invention also relates to programs to be executed by such information processing apparatuses.

2. Description of the Related Art

When data stored on various types or storage media, such as hard disc drives (HDDs), is managed, a file system is often used to manage the data as files. Examples of the format of such a file system include FAT (File Allocation Table) and HFS (Hierarchical File System).

With such a file system acting between, for example, an application and a driver or the like of a storage medium, the application is allowed to execute file operations, such as an operation for reading data from or writing data to a file, without being aware of the physical data storage structure on the storage medium.

Furthermore, recently, the storage capacities of various types of storage media are increasing due to factors such as reduction in cost per bit and improvement in recording density. Also, the speed of various types of information processing is being improved. Under the situation described above, it is becoming possible to store files of data of content (content files) including, for example, a large number of still pictures, moving pictures, or sounds.

Under the current situation, examples of apparatuses available for recording and playing back content such as still pictures, moving pictures, or sounds include digital still cameras and digital video cameras. As it becomes possible to store a large number of content files on a storage medium as described above, factors such as ease of searching and browsing and richness of accompanying information become important in view of convenience for users.

As described earlier, a file system is intended to be used for managing data stored on a storage medium as files. Thus, file-related information items defined by the file system are limited to basic information items, such as file name (with extension), file size, date and time of creation, and date and time of updating. For example, in the case of a content file representing an image, it is preferable to allow presenting various types of information other than the basic information, for example, in the form of a list. However, this is difficult to achieve only by file management based on the file system.

Furthermore, since file systems are adopted as a basic element in various types of storage media, such as HDDs, conversely, it is difficult to extend the accompanying information or the like.

In view of this situation, according to some schemes that have been proposed and put into practice, files stored on a storage medium are generally managed on the basis of a file system, and management information in a file format (management file) including information provided specifically for managing content files stored on the storage medium is used. Such a scheme is disclosed, for example, in Japanese Unexamined Patent Application Publication No. 2004-227630.

As an example of a device that manages content files using a management file as described above, an imaging device, such as a digital video camera or a digital still camera, can be considered. Recently, most imaging devices of such types support the USB (Universal Serial Bus) mass storage class. When a device supporting the USB mass storage class is connected to a personal computer or the like, without installing driver software on the host, the personal computer can recognize a storage medium of the device as an external storage device connected to the personal computer, and normally access the storage device.

However, when the imaging device supports the USB mass storage class as described above, it is possible to perform operations such as recording a file, deleting a file, or updating a file on the storage medium of the imaging device by a normal file operation executed at the personal computer connected by USB.

Thus, it is possible that a file operation such as modification or deletion is executed on the management file stored on the storage medium of the imaging device under the control of the personal computer, for example, due to a user operation or an effect of certain file processing. When an operation is executed on the management file under the control of the personal computer as described above, file system management information is also updated in accordance with the result of the operation under the control of the personal computer. At this time, however, the content of the management file is modified irrelevantly to the actual statue of management of content files.

When the USB connection with the personal computer is closed with the content of the management file maintained, the status of management of content files as indicated by the management file could be inconsistent with the status of management of content files on the basis of the file system. That is, the content of the management file might be invalid and reliability is not ensured, so that the validity of the management file is lost.

The loss of the validity of the management file could occur on each occasion of a USB mass storage class connection. When the imaging device is operated with the invalid content of the management file, problems could arise, such as an incorrect operation of the device or an inappropriate display of a list of content files. Thus, the imaging device should at least check whether the content of the management file is valid on each occasion of closing of a USB connection.

The validity of the management file can be checked, for example, by executing comparison between all the content files as managed on the basis of the management file and all the content files as managed on the basis of the file system. When the comparison results in matching for all the content files, the management file is determined as valid. However, processing for such comparison involves frequent accesses to the storage medium, and the comparison itself causes a considerable load, so that a certain processing tike is taken. In order to complete activation of the imaging device on an occasion of closing of a USB connection, the checking of inconsistency is to be also completed. Thus, the performance of the system of the imaging device regarding activation on an occasion of closing of a USB connection is degraded.

### SUMMARY OF THE INVENTION

According to an embodiment of the present invention, there is provided an information processing apparatus including basic file management means for managing files stored on a storage medium using basic file management information stored on the storage medium; specific file management means for managing a file of a specific type, among the files managed by the basic file management means, using specific file management information stored on the storage medium as one of the files managed by the basic file management means; reference-information management means for storing reference information relating to the specific file management information, the reference information having meanings corresponding to predetermined information items in the basic file management information, the predetermined information items being provided for each of the files, and for updating the reference information in accordance with updating of the specific file management information; and validity checking means for checking validity of the specific file management information by comparing the stored reference information with information items having meanings corresponding to the reference information relating to the specific file management information in the basic file management information.

In the information processing apparatus described above, files stored on a storage medium are generally managed using basic file management information. Furthermore, a file of a specific type among the files managed using the basic file management information is also managed using specific file management information. The specific file management information is handled as a file that is managed using the basic file management information.

Under the file management scheme described above, reference information relating to the specific file management information is stored. The reference information has meanings corresponding to predetermined information items provided for each of the files and included in the basic file management information, and the reference information is updated in accordance with updating of the specific file management information. That is, the reference information is supposed to have content in accordance with latest specific file management information.

Furthermore, when checking the validity of the specific file management information, the stored reference information at that time is compared with the information having corresponding meanings in information for managing the specific file management information in the basic file management information. When the comparison results in a mismatch, it is indicated that the occasion of updating the specific file management information as managed on the basis of the basic file management information differs from the occasion of updating the specific file management information as indicated by the reference information. Thus, the validity of the specific file management information is not ensured. On the other hand, when the comparison results in a match, it is indicated that these updating occasions coincide with each other. Thus, it is determined that the validity of the specific file management information is ensured.

According to the embodiment of the present invention described above, when checking the validity of the specific file management information, it suffices to compare only information items corresponding to the reference information between the specific file management information and the basic file management information. Thus, according to the embodiment, the time taken for checking the validity is considerably reduced compared with a case in which, for example, a comparison is executed between all the files of a specific type as managed on the basis of the management file and all the files of a specific type as managed by the file system. The reduction in the processing time for checking the validity of the specific file management information also serves to reduce, for example, the activation time of the apparatus.

### BRIEF DESCRIPTION OF THE DRAWINGS

FIG. 1 is a block diagram of showing an example of the configuration of a digital video camera as an information processing apparatus according to an embodiment of the present invention;

FIG. 2 is a diagram showing a directory structure in an example of management of content files, a management file, and a backup file on the basis of a file system;

FIG. 3 is a diagram schematically showing an example of the structure of the management file;

FIG. 4 is a diagram showing a hierarchical model of system configuration regarding access to a medium (HDD) in the digital video camera according to the embodiment;

FIGS. 5A to 5C are diagrams showing examples of inconsistencies that occur due to operations on files stored on the HDD of the digital video camera according to the embodiment, executed by an external information processing apparatus;

FIG. 6 is a flowchart showing a procedure of processing backup information items relating to processing of a content file in the digital video camera according to the embodiment; and

FIG. 7 is a flowchart showing a procedure of checking the validity of the management file in the digital video camera according to the embodiment.

### DETAILED DESCRIPTION

Now, an embodiment of the present invention will be described. The embodiment will be described in the context of an example where an information processing apparatus according to the present invention is configured as a digital video camera.

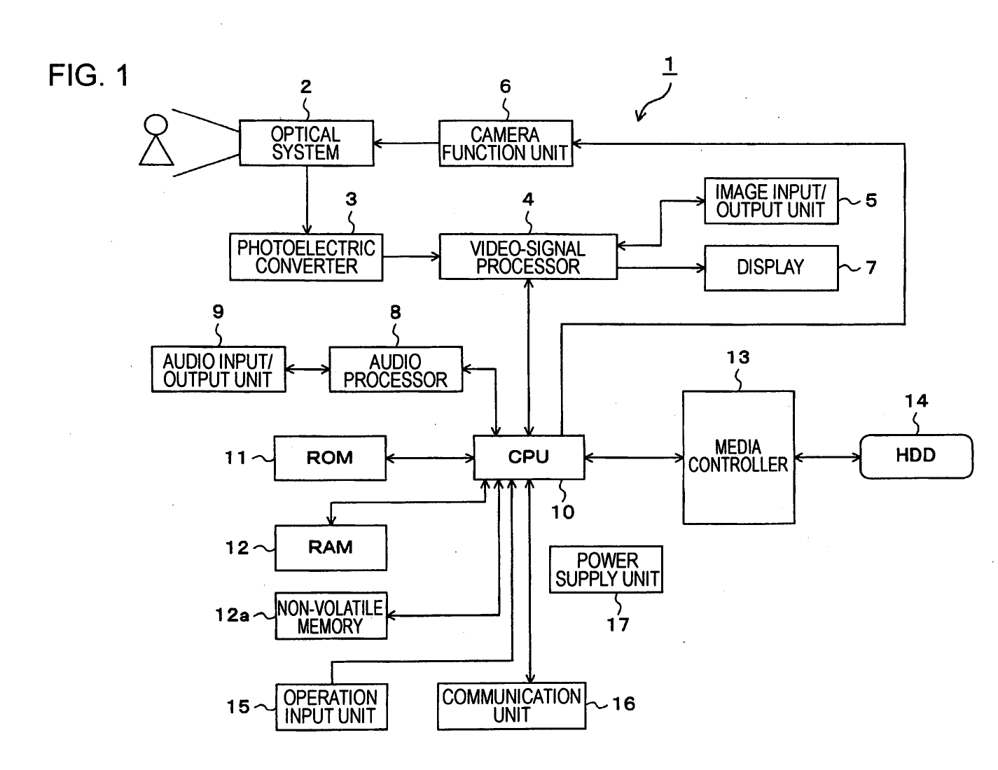

FIG. 1 is a block diagram showing an example of the configuration of a digital video camera 1 according to the embodiment.

Referring to FIG. 1, in the digital video camera 1, an optical system 2 includes an imaging lens, a diaphragm, and other associated parts, and incident light representing an image that has been taken is focused at a photoelectric converter 3. Furthermore, the optical system 2 includes a focus adjusting mechanism for adjusting the focus, an aperture changing mechanism for changing the aperture according to an aperture value, and so forth. These mechanisms are driven according to driving signals output from a camera function unit 6. The camera function unit 6 outputs appropriate driving signals under the control of a central processing unit (CPU) 10 so that appropriate focusing and aperture size will be achieved.

Furthermore, for example, when an optical zoom function is to be provided, a zoom mechanism for moving a zoom lens in the optical system 2 is provided, and a driving unit that moves the zoom mechanism under the control of the CPU 10 similarly to the mechanisms described above is provided. Furthermore, a stroboscopic lamp may be provided in the camera function unit 6 to provide a function of emitting stroboscopic light.

The photoelectric converter 3 includes a photoelectric conversion device, such as a charge coupled device (CCD) or a complementary metal oxide semiconductor (CMOS) sensor. The photoelectric converter 3 executes photoelectric conversion of captured light coming through the optical system 2 and focused on a photoreception surface to generate captured image signals, and outputs the captured image signals to a video-signal processor 4. At an occasion of taking an image, the CPU 10 issues an instruction of a shutter speed to the video-signal processor 4, the shutter speed being determined on the basis of, for example, a result of exposure setting. The video-signal processor 4 outputs scanning timing signals corresponding to the shutter speed to the photoelectric converter 3. The photoelectric converter 3 executes scanning according to the scanning timing signals, thereby executing photoelectric conversion, and outputs resulting video signals.

The video-signal processor 4 executes waveform shaping of the analog video signals (captured image signals) input from the photoelectric converter 3, for example, through gain adjustment and sample and hold processing, and executes A/D conversion, thereby converting the analog video signals into digital video signals. Then, the video-signal processor 4 executes video signal processing on the digital video signals obtained through the conversion, such as generation of luminance data for display, for allowing display on a display 7. Together with the video signal processing, the video-signal processor 4 can also execute signal processing for what is called on-screen display so that character images or other types of images can be displayed as superposed on the captured image under the control of the CPU 10.

An actual display device that is used as the display 7 is not particularly limited. Under the current situation, a liquid display panel is typically used.

Furthermore, the video-signal processor 4 is capable of executing, for example, encoding for compression according to a predetermined scheme on the digital video signals obtained through the conversion of the analog video signals input from the photoelectric converter 3, thereby generating compressed video data.

Furthermore, the digital video camera 1 is also capable of operating as a still camera. That is, the digital video camera 1 is capable of generating still-picture data files representing captured images in a predetermined format, and the video-signal processor 4 can also execute processing for this purpose.

Furthermore, the video-signal processor 4 is also capable of converting image (video) signals input from the photoelectric converter 3, files of audio-video (AV) data (AV files) read from a medium as will be described later, or the like into analog video signals or digital video signals in a predetermined format, and outputting the analog video signals or digital video signals to an external device or the like via an image input/output unit 5.

The image input/output unit 5 is also capable of receiving input of video signals in a predetermined format from outside, and it is possible to process the input video signals in the video-signal processor 4 and to display a corresponding image on the display 7. Furthermore, the video-signal processor 4 can convert the video signals input via the image input/output unit 5 into data for recording and to transfer the data to a media controller 13, similarly to the case of the analog video signals input from the photoelectric converter 3.

For this purpose, the image input/output unit 5 has, for example, a video (image) signal input terminal/output terminal compliant with the predetermined format.

Furthermore, the digital video camera 1 according to this embodiment includes an audio processor 8 and an audio input/output unit 9 so that audio signals can be input and output.

Regarding audio input, the audio input/output unit 9 includes a microphone or the like so that external sound can be collected and converted into audio signals for audio input. The audio signals input in this manner are supplied to the audio processor 8. The audio processor 8 executes audio signal processing, such as conversion into compressed audio data encoded according to an audio encoding scheme for compression corresponding to the encoding for compression of the captured image.

The CPU 10 exercises control to generate an AV file in a predetermined format, composed of compressed video data of the captured image, obtained by the video-signal processor 4, and compressed audio data of the collected sound, obtained by the audio processor 8. The AV file is configured so that sound output by playing back the compressed audio data is played back in synchronization with a moving picture output by playing back the compressed video data. The AV file may be actually formed by software, i.e., through digital signal processing executed by the CPU 10 according to a program. Alternatively, hardware for forming an AV file may be provided, the operation of the hardware being controlled by the CPU 10.

For example, data of the AV file is transferred to the media controller 13 under the control of the CPU 10 as data for recording. The CPU 10 can also transfer a still-picture data file in a predetermined format, representing a picture image generated by the video-signal processor 4, to the media controller 13 as data for recording.

The audio input/output unit 9 may have an audio-signal input terminal or the like so that audio signals can be input from an external audio device or the like. The audio signals input via the audio-signal input terminal are converted by the audio processor 8 into a digital audio file in a predetermined format. The CPU 10 can also transfer data of the digital audio data file to the media controller 13 as data for recording.

The media controller 13, in cooperation with the CPU 10, is capable of exercising control relating to data processing involving a certain type of medium (storage medium). The data processing involving the medium herein refers to processing relating in some way to data that is to be stored on the medium, such as formatting of the medium, and writing/reading of files, information for file management, etc. on storage areas of the medium.

In this embodiment, as an example, a hard disc drive (HDD) 14 is connected to the media controller 13. As is known, an HDD is a storage device including a magnetic disc as a storage medium. Under the current situation, an HDD is considered as a type of storage medium having a lowest cost per bit and having a favorable recording density. With an HDD, it is possible to provide a large storage capacity on a gigabyte order at a relatively low cost. Furthermore, as is known, data is physically read from or written to a magnetic disc as a storage medium by applying a magnetic field or detecting a magnetic field while tracing tracks on the magnetic disc.

The HDD 14 in this embodiment is, for example, internally fixed in the digital video camera 1. Alternatively, the HDD 14 may be a removable medium compliant with a certain standard so that the HDD 14 can be attached to and detached from the digital video camera 1 (host).

When data for recording has been transferred in the manner described earlier, the media controller 13 further transfers the data for recording to a medium selected as a destination among media connected to the media controller 13 (the HDD 14 in this example). At the medium at the destination of transfer of the data, the data is written to and stored in a storage area according to an instruction from the media controller 13. The data stored on the medium in this manner is stored and managed as a file. The file stored on the medium is managed on the basis of a predetermined file system.

Furthermore, for example, when an AV file is played back among files stored on the medium, the CPU 10 and the media controller 13 access and read the specified AV file. The AV file that is read in this manner is separated into compressed video data and compressed audio data, for example, through processing executed by the CPU 10, and the compressed video data is passed to the video-signal processor 4 while the compressed audio data is passed to the audio processor 8.

In this example, the video-signal processor 4 and the audio processor 8 execute signal processing for playback including demodulation regarding the compressed video data and the compressed audio data transferred thereto as described above, respectively. Thus, an image obtained by playing back the compressed video data is displayed on the display 8, and audio signals obtained by playing back the compressed audio data are output as sound via a speaker of the audio input/output unit 9 or via a headphone terminal in synchronization with the playback of the image.

Furthermore, for example, an audio data file that is played back from the medium can be output as audio signals or audio data in a predetermined format to outside via the audio input/output unit 9 after audio signal processing in the audio processor 8. In this case, the audio input/output unit 9 is configured to have an audio output terminal compliant with the predetermined format of audio signals or audio data output from the audio processor 8.

The CPU 10 exercises control in various manners for the operation of the digital video camera 1 by executing programs. A read-only memory (ROM) 11 stores various programs executed by the CPU 10, various setting information used for processing by the CPU 10, and so forth. A random access memory (RAM) 12 is used as a work area when the CPU 10 executes processing according to a program, and data of results of various operations or the like is stored in the RAM 12.

Furthermore, a non-volatile memory 12a is formed of a memory element in which stored data is not discarded even when power supply is stopped, such as a flash memory. Data is written to and read from the non-volatile memory 12a under the control of the CPU 10. Generally, data (information) that is to be stored in the non-volatile memory 12a is, for example, setting information or the like whose content is updated as appropriate. However, without limitation to particular types of information, various types of information may be stored as appropriate in accordance with the actual specification of the digital video camera 1 and other relevant factors.

The operation input unit 15 herein refers collectively to various operating elements provided in the digital video camera 1. The operating elements of the operation input unit 15 include, for example, a shutter button that is operated when taking a picture, operating elements for selecting an imaging mode or the like, and operating elements for increasing or decreasing parameter values.

The communication unit 16 includes hardware and software for carrying out communications with external devices according to a predetermined data communication protocol under the control of the CPU 10. In this embodiment, the communication unit 16 is compliant with the USB (Universal Serial Bus) standard. Furthermore, the digital video camera 1 supports the USB mass storage class.

Since the USB mass storage class is supported, for example, when the digital video camera 1 according to this embodiment is connected by USB with an external information processing apparatus, such as a personal computer, the external information processing apparatus can mount the HDD 14, which is a medium on the side of the digital video camera 1, as an external removable medium and access the HDD 14.

For example, content files stored on a storage medium of a digital imaging device, such as a digital video camera or a digital still camera, are often copied to an HDD of a personal computer so that the content files can be managed or edited by application software of the personal computer. In this case, similarly to the digital video camera 1 according to this embodiment, when the digital imaging device supports the USB mass storage class, the digital imaging device can be connected to the personal computer without installing a driver or the like in order to store content files in the personal computer. This serves to achieve simplicity and versatility.

The data communication protocol supported by the communication unit 16 is not particularly limited regardless of distinction between wired and wireless communications. Furthermore, the number of data communication protocols supported is not limited. Under the current situation, examples of data communication protocols include, in addition to USB described above, network protocols such as Ethernet™ or data bus protocols such as IEEE (the Institute of Electrical and Electronic Engineers) 1394 in the case of wired communications, and inter-device short-range wireless communication protocols such as Bluetooth™ or wireless LAN (local area network) protocols such as IEEE 802.11a/b/g in the case of wireless communications.

The power supply unit 17 supplies power for operation to various hardware devices in the digital video camera 1. The power supply unit 17 includes a power supply circuit that operates with power received from a battery, a power supply adaptor, or the like.

As described above, in the digital video camera 1 according to this embodiment, an AV file of a moving picture obtained by imaging and collection of sound or a still-picture file of a still picture can be stored on a medium (the HDD 14).

Files stored on the medium are usually managed on the basis of a file system of a predetermined format. In this embodiment, files are managed on the basis of the FAT (File Allocation Table) file system. As is known, in the FAT file system, files are managed by a tree-shaped directory structure, and data is read and written in logical minimum data management units called clusters. A cluster corresponds to a unit including a predetermined number of sectors, which are physical minimum units of writing data to or reading data from the medium.

In this embodiment, among files that are managed on the basis of the file system (FAT) and stored on the medium as described above, AV files (moving-picture files) or still-picture files of pictures or the like are distinguished from files such as system-related files, since these files are classified as content files, i.e., files for which the content of information that is played back and output is meaningful for the user.

Furthermore, in this embodiment, files stored on the HDD 14 include a content management file (hereinafter simply referred to as a management file) including management information that is provided specifically for managing the content files.

Furthermore, in this embodiment, a backup file of the management file is generated and stored on the HDD 14.

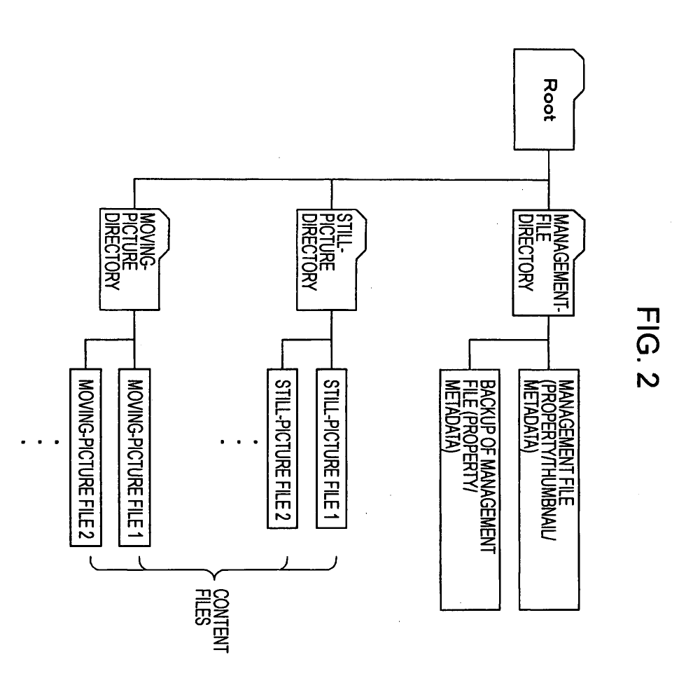

FIG. 2 is a directory structure of the HDD 14 in the digital video camera 1 according to this embodiment, which is formed on the basis of the FAT file system.

In the directory structure of the HDD 14, for example, as shown in FIG. 2, immediately under a Root directory, a management-file directory, a still-picture directory, and a moving-picture directory are provided.

Of these directories, the still-picture directory and the moving-picture directory serve as directories for storing content files. That is, the still-picture directory stores one or more still picture files of pictures or the like, and the moving-picture directory stores moving-picture files such as the AV files described earlier.

The management-file directory stores a management file and a backup file of the management file. As will be described later, in this embodiment, the management file is actually composed of, for example, a property file, a thumbnail file, and a metadata file. The backup file of the management file is composed of backups of the property file and the metadata file.

The thumbnail file includes image data so that it has a considerably large file size. Thus, it is possible to save storage capacity by not taking a backup of the thumbnail file. The thumbnail file can be reconstructed at any time as long as consistency is maintained between the management file and the file system. For these reasons, the thumbnail file is not included in the backup file.

When saving of storage capacity does not matter, for example, when the storage medium has an extremely large capacity, or when backup of the thumbnail file has a higher priority due to system specifications or other factors, the thumbnail file can be included in the backup file without causing any particular problem.

Furthermore, in this embodiment, the management-file directory is configured so that it is invisible during ordinary use. Thus, the management file and the backup file stored in the management-file directory are also invisible. Since these management file and backup file are files that are used by the system for content management, preferably, for example, unintended deletion or rewriting by the user is to be prohibited. This is why these files are managed as invisible files in this embodiment as described above.

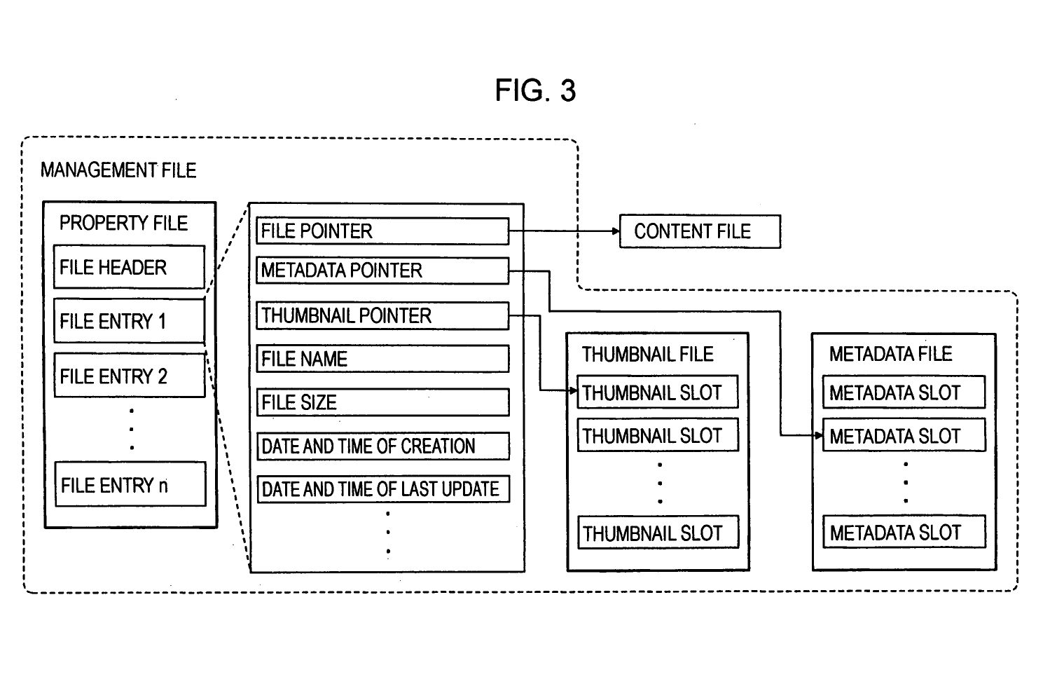

FIG. 3 shows an example of the structure of the management file in this embodiment.

As described earlier, the management file can be divided into a property file, a thumbnail file, and a metadata file. In this embodiment, a set of the property file, the thumbnail file, and the metadata file is used as the management file. Among the property file, the thumbnail file, and the metadata file, the property file is necessary and the thumbnail file and the metadata file are optional.

As shown in FIG. 3, the property file is configured as a set of a file header and one or more file entries (1 to n). The individual file entries correspond to content files on a one-to-one basis, and include basic information relating to the individually associated content files. The structure of each entry file will be described later.

The thumbnail file includes one or more thumbnail slots. Basically, each thumbnail slot is associated with one content file, and includes thumbnail image data corresponding to a representative image representing the associated content file.

The metadata file includes one or more metadata slots. Each metadata slot is also associated with one content file. A title slot can store arbitrary information items, such as data in text format (for comments or the like) or information regarding grouping of content files.

Although not shown, the internal structure of the file header in the property file includes, for example, information representing date and time of creation and date and time of updating of the current property file, information representing the size of each file entry, information representing the number of file entries included, a thumbnail-file list, a metadata-file list, and so forth.

The thumbnail-file list includes information representing date and time of creation and date and time of updating of each thumbnail file, information representing the size of each thumbnail slot, information representing the number of thumbnail slots included, and so forth.

The metadata-file list includes information representing the date and time of creation and date and time of modification of each metadata file, information representing the size of each metadata slot, information representing the number of metadata slots included, and so forth.

The structure of each file entry in the property file includes, for example, as shown in FIG. 3, a file pointer, a metadata pointer, a thumbnail pointer, a file name, a file size, a date and time of creation, a date and time of updating, and so forth.

The file pointer is a pointer pointing to the associated content file. The pointer identifies the location of the associated content file, for example, by a path managed by the file system.

The thumbnail pointer points to a thumbnail slot that is associated with the current file entry (i.e., a thumbnail slot associated with the content file pointed to by the file pointer of the current file entry) in the thumbnail file. The thumbnail file is formed, for example, by logically concatenating fixed-length thumbnail slots. Thus, the thumbnail pointer allows identification of a thumbnail slot by specifying an order of the thumbnail slot in the thumbnail file.

The thumbnail image data stored in the thumbnail slots in the thumbnail file may be displayed as icons (thumbnail images) representing files when a file-list image is displayed on the display 7.

The metadata pointer points to a metadata slot associated with the current file entry (i.e., a metadata slot associated with the content file pointed to by the file pointer of the current file entry) in the metadata file. The metadata file is also formed, for example, by logically concatenating fixed-length metadata slots. Thus, the metadata pointer also allows identification of a metadata slot, for example, by specifying an order of the metadata slot in the metadata file.

Furthermore, fields of file name, file size, date and time of creation, and date and time of updating, provided in each file entry, includes information representing a file name, a size, a date and time of creation, and a date and time of updating of the content file pointed to by the file pointer of the current file entry.

Furthermore, although not shown, in each file entry, it is possible to include information other than the file pointer, metadata pointer, thumbnail pointer, file name, file size, date and time of creation, and date and time of updating described above. For example, when a system that uses the management file in this embodiment includes a device associated with a positioning system such as the Global Positioning System (GPS), position information or the like obtained by the positioning system is stored as an information item in the file entry.

As will be understood from the above description, each content file stored on the medium (HDD 14) of the digital video camera 1 is associated with a file entry by a file pointer in the file entry. A thumbnail slot is identified by referring to a thumbnail pointer in the file entry, and this thumbnail slot corresponds to the content file pointed to by the file pointer. Also, a metadata slot specified by the metadata pointer of the file entry is associated with the content file pointed to by the file pointer.

That is, by the management file, one content file stored on the medium is associated with thumbnail image data corresponding to the content file (thumbnail slot) and information of arbitrary content relating to the content file (metadata slot) on the basis of the pointer of the property file.

An application that processes content files uses such file management information, so that content files can be managed more efficiently compared with a case where management of content files is based on a file system alone. For example, when searching for a file, by adding information includes in a file entry, information included in a metadata slot, or the like as a search condition, it is possible to execute searching using a larger number of search conditions than in a case where management of content files is based on a file system alone. That is, a more sophisticated searching function can be provided. Furthermore, this is advantageous when displaying a content file stored in the HDD 14 on the display 7. For example, when displaying a thumbnail image, the thumbnail image can be read from a thumbnail file and played back for output. Thus, it is not needed to access data of a content file on the HDD 14 and to generate a thumbnail image on each occasion, so that a list screen can be displayed quickly. Furthermore, it is also possible to present various types of accompanying information in the form of a list, using information included in a file entry, information included in a metadata slot, or the like.

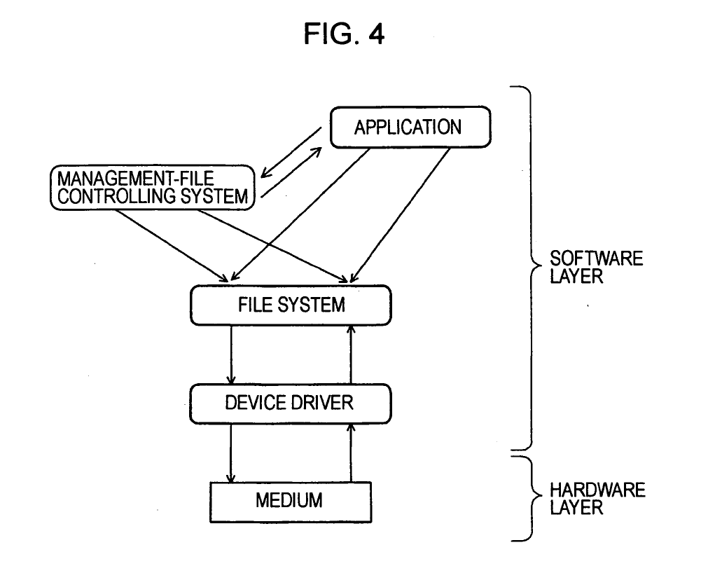

FIG. 4 shows a hierarchical model of a system configuration in a case where files are managed on the basis of the FAT file system and content files are managed using a management file. The hierarchical model can be generally divided into a software layer and a hardware layer below the software layer.

In this example, the software layer corresponds to software processing achieved by programs, various types of firmware or middleware, or the like, executed by a CPU in a device that serves as a host (the digital video camera 1 in this embodiment) for the medium. In this example, the software layer basically includes layers of application, file system, device driver, in that order from top to bottom, and also includes a management-file controlling system, as shown in FIG. 4.

The hardware layer can be considered as a layer of the physical storage area of the medium (HDD 14) itself.

The application in this example has various processing functions (recording, playback, updating, etc.) involving files, and the application issues file-level access requests to the management-file controlling system.

The file system corresponds to software implementing the functions of the file system. In this embodiment, the FAT file system is used, so that the software for providing the functions of the file system is configured correspondingly to the FAT file system.

As is known, in the FAT file system, stored files are managed on the basis of a tree-shaped directory structure, and files are managed as sets of clusters. The file management and data management described above are achieved using management information (file-system management information) including directory entries and table information called FAT (File Allocation Table). A directory entry is information indicating a location of a file or directory (subdirectory) on a medium at a cluster level. The FAT is information representing a chain (link or connection) on a level of clusters constituting a directory or file. Access to these pieces of file-system management information (directory entries and FAT) and operations on these pieces of file-system management information, such as updating of the file-system management information in accordance with results of file operations such as reading (playback) or writing (appending or updating), are executed in the file-system layer.

The file system converts the file-level access requests from the application (and the management-file controlling system described later) into a level of clusters that serve as units of data management in the format of the FAT file system, and issues access requests to a device driver.

The device driver corresponds to software for controlling a medium that serves as a device to be controlled. The device driver converts the cluster-level access requests based on the FAT file system format from the file system into a level of sectors that serve as units of writing data to or reading data from the medium, and issues requests for accessing the medium.

In this example, the medium is logically formatted (initialized) on the basis of the FAT file system. In FIG. 1, the HDD 14 corresponds to the medium. In response to a sector-level access request from the device driver, data is read from a specified sector address of the medium and the data is returned to the device driver. That is, an access response on a sector level is executed.

The device driver receives sector-level access responses, i.e., receives data of individual sectors from the medium. Then, the device driver passes the data to the file system on a cluster-by-cluster basis (cluster-level access responses).

The file system passes the data received from the device driver to the application as file-level data. The application executes suitable application-level processing on the data received as a file, for example, in accordance with an operation entered by the user.

The management-file controlling system corresponds to software implementing file operating functions such as generating the management file shown in FIG. 3, reading data from a medium, or writing data to a medium. For example, when the application searches for a content file using the management file, the management file read and retrieved from the medium under the control of the management-file controlling system is referred to.

As another example, when the application executes a file operation, such as recording, deletion, or updating of a content file, an access request is sent and data that has been read is received via the management-file controlling system. In this case, the application and the management-file controlling system carry out file-level communications using, for example, a file name, or a mutually agreed upon file ID.

Furthermore, in accordance with the result of the file operation by the application described above, the management-file controlling system updates (rewrites) the management file so that the result of the operation is reflected. The management-file controlling system executes operations on the management file as described above. Furthermore, in this embodiment, as described with reference to FIG. 2, a backup file of the management file exists, so that the backup file is to be also updated in accordance with the result of operation on the content file by the application. The management-file controlling system also executes file operations on the backup file.

For example, when the management-file controlling system issues a request for accessing the management file, similarly to the application, the management-file controlling system issues the request to the file system on a file level. In layers lower than the layer of the file system, data is passed in response to the access request similarly to the case described above, whereby data of the management file is returned to the management-file controlling system.

As will be understood from the above description, in the digital video camera 1 according to this embodiment, files stored on a storage medium are generally managed on the basis of a file system (basic file management means) (FAT in this embodiment), and furthermore, among the files, content files (files of a specific type) are also managed on the basis of a management file. In the scheme of file management described above, in order to achieve proper file management, the status of file management by the file system based on file management information should be consistent with the status of file management based on the management file.

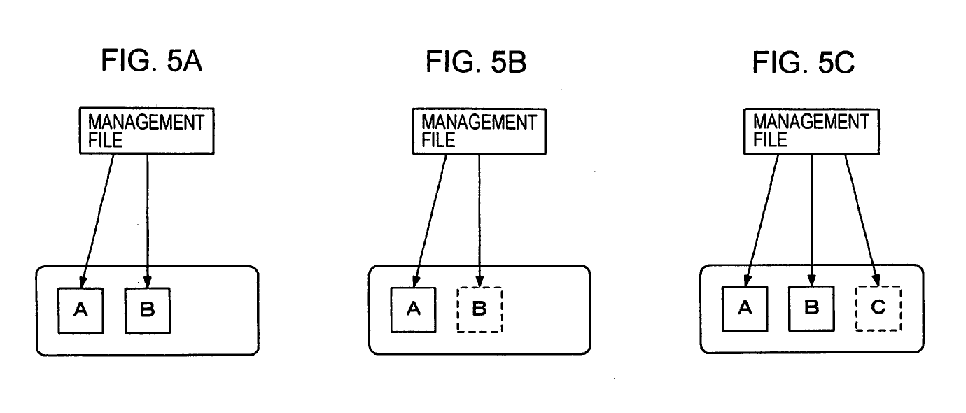

In the digital video camera 1 according to this embodiment, the USB mass storage class is supported, as described earlier with reference to FIG. 1. The support for the USB mass storage class means that a personal computer or the like, connected by USB, can execute a file operation or the like considering the HDD 14 of the digital video camera 1 as an external storage device mounted thereon. This could cause inconsistency between the status of file management based on the file system and the status of file management based on the management file. This will be described with reference to FIGS. 5A to 5C.

FIG. 5A schematically shows a state where two files, namely, content files A and B, are managed on the basis of a file system and the content files A and B are managed appropriately on the basis of a management file.

As an example, let it be supposed that the digital video camera 1 according to this embodiment is connected by USB to an external information processing apparatus, such as a personal computer, under the state shown in FIG. 5A.

Since the digital video camera 1 according to this embodiment supports the USB mass storage class, the HDD 14 of the digital video camera 1 is seen by the external information processing apparatus as an external storage device, and operations of files in the HDD 14 from the external information processing apparatus (e.g., new recording, deletion, or modification of files) are allowed. That is, for example, by user's operations of the external information processing apparatus, it is possible to newly record files on the HDD 14, delete files from the HDD 14, or read and modify files by the external information processing apparatus and rewrite (update) files on the HDD 14.

As described earlier, the management file in this embodiment is stored in the HDD 14 as a file that is managed by the file system. Thus, when the digital video camera 1 according to this embodiment is connected to the information processing apparatus with the USB mass storage class, it is possible to perform operations on the management file by exercising control from the external information processing apparatus. As described earlier, the management file in this embodiment is managed as an invisible file. However, it is possible to change an invisible file to a visible file by an external information processing apparatus such as a computer. Thus, being an invisible file does not ensure complete protection against unintended alteration or modification.

As a result of modification of the management file by a personal computer in the state of file management shown in FIG. 5A, the association between the management file and the content file B becomes absent, as shown in FIG. 5B. This state appears when, for example, information for managing the content file B in the management file is lost due to the modification of the content of the management file.

FIG. 5C shows a state where, as a result of modification of the management file by the external information processing apparatus, a content file C, which is not supposed to exist on the file system, is under management on the basis of the management file as well as the content files A and B.

Furthermore, although not shown in FIGS. 5A to 5C, it is possible that the management file itself is deleted by a file operation executed under the control of the external information processing apparatus. In this case, although content files are stored on the HDD 14, the management file indicates that no content files are recorded, so that an inconsistency arises.

With the digital video camera 1 according to this embodiment connected to an external information processing apparatus with the USB mass storage class as described above, when an operation on the management file is executed by a file operation on the HDD 14 from the external information processing apparatus, an inconsistency arises between the status of management of content files based on the file system and the status of management of content files based on the management file. This sort of inconsistency arises due to unintended modification of the management file on an occasion irrelevant to an operation of a content file. Thus, the inconsistency indicates a state where the reliability of the management file is not ensured and the content of the management file is not valid.

Let it be supposed that with the validity of the management file lost, for example, as in FIG. 5B or FIG. 5C, the USB connection between the digital video camera 1 and the personal computer is released so that the digital video camera 1 is returned to a state for independent use. At this time, it is not recognized by the digital video camera 1 that the content of the management file has become invalid and that an inconsistency has arisen. When a normal operation is executed without the digital video camera 1 recognizing the invalidity of the content of the management file, problems could occur, such as an incorrect operation or presentation of an inappropriate management file, causing confusion for the user. For example, let it be supposed that an index display of content files is executed under a state of inconsistency shown in FIG. 5C, in which the content file C is managed as not stored on the file system while being a subject of management appropriately in the management file. The index display refers to an image displayed on the display 7 in order to present an index of content files stored on the HDD 14.

In this case, it is assumed in the management file that the content file C is stored on the HDD 14. Thus, the index display indicates that the content file C is stored on the HDD 14 and that the content file C can be played back normally. However, even when the content file C in the index display is specified and playback thereof is requested, since the content file C has already been deleted on the file system, it is not allowed to access the content file C on the HDD 14, so that a playback error occurs. This could confuse the user, and likely to cause an operation error, such as a hang-up of the digital video camera 1.

Thus, in this embodiment, in order to avoid this problem, the following scheme is employed.

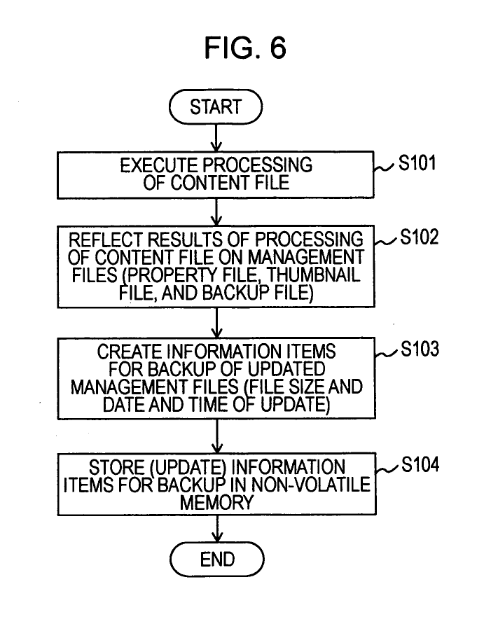

FIG. 6 shows a flowchart of a procedure of processing that is executed in response to execution of processing corresponding to a certain file operation involving a content file, such as new recording, deletion, or modification (updating), while the digital video camera 1 is being used independently.

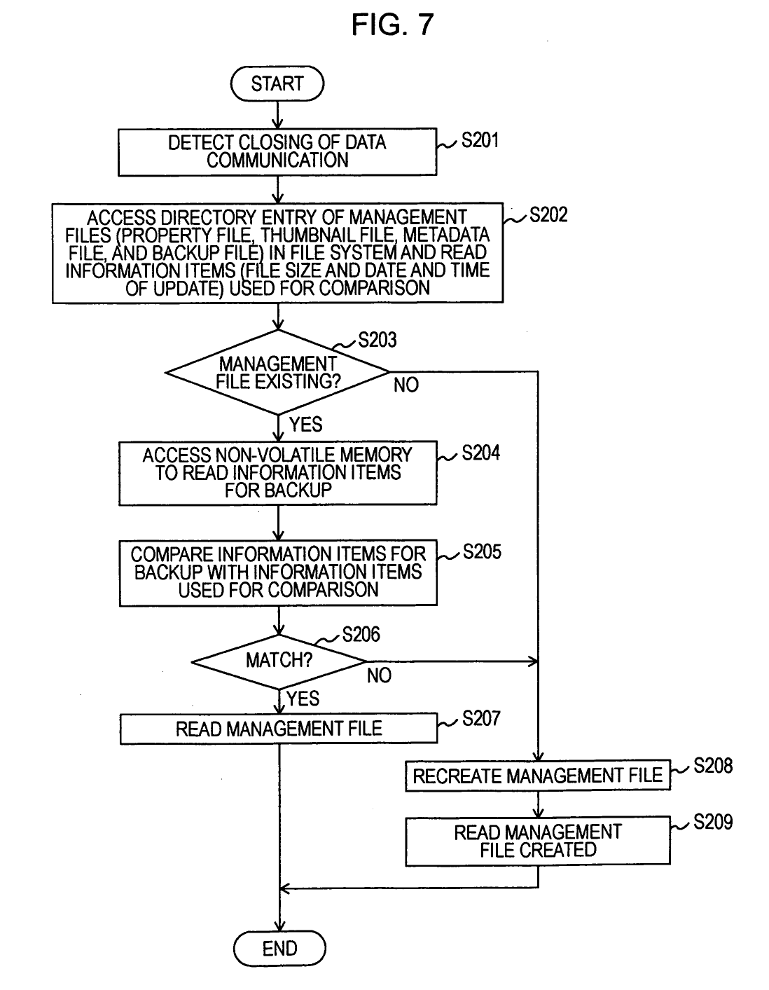

The process shown in FIG. 6 is achieved by execution of programs corresponding to the software layer shown in FIG. 2 (application, management-file controlling system, file system, and device driver) by a hardware device capable of executing programs, such as the CPU 10. The programs are stored, for example, in the ROM 11, the non-volatile memory 12a, or the HDD 14. Alternatively, for example, the programs may be stored on a removable storage medium and later installed from the storage medium onto the digital video camera 1. Yet alternatively, the programs may be stored on a storage medium at a server or the like on a network and obtained by downloading via the network and installed on the digital video camera 1. This similarly applies to a flowchart shown in FIG. 7, which will be described later.

Referring to FIG. 6, certain processing involving a content file is executed in step S101. In accordance with the result of the processing, in step S102, the management file is updated so as to reflect the result of processing of the content file.

Then, in step S103, in accordance with the result of updating of the management file in step S102, backup information items (reference information) are created.

The backup information items herein include two information items, namely, the file size and the date and time of updating of the management file. Thus, in step S103, the size of the management file obtained through updating in step S102 is set as the content of the information item for file size, and information representing the date and time of the updating is set as the content of the information item for date and time of updating. Then, backup information items are obtained in the form of a collection of these information items.

The backup information items created in step S103 as described above are written to and stored in the non-volatile memory 12a through step S104. For example, when the processing of a content file executed in step S101 is initial recording of a content file in a blank state where no content file has been recorded on the HDD 14, through the processing in steps S102 to S104, an operation for newly creating a management file and storing the management file on the HDD 14 and an operation for newly creating backup information items and storing the backup information items on the non-volatile memory 12a are executed. When the processing of a content file executed in step S101 is additional recording, deletion, modification, or the like of a content file executed after the initial recording, through steps S102 to S104, updating of the management file and updating of the backup information items are executed. The backup information items herein include file size and date and time of updating.

In FAT, which is the file system used in this embodiment, as is known, the structure of a directory entry, which is defined as entry information for each directory (file), include information items of file name, file size, date and time of creation, and date and time of updating. Of these information items, the file size, date and size of creation, and date and time of updating are common to the backup information items and have corresponding meanings. That is, of the information items assigned to each file in the file management information of the file system, predetermined corresponding items are selected for the backup information items.

Since the backup information items have the characteristics described above, in step S103, it is possible to read and obtain information items of file size and date and time of updating, stored in a directory entry for managing the management file, and to create backup information items using the information items.

As shown in FIG. 3, the management file is actually composed of a property file, a thumbnail file, and a metadata file. Furthermore, as shown in FIG. 2, a backup file of the management file is provided. The backup file is also composed of files corresponding to the property file, thumbnail file, and metadata file. Actually, all of these files are managed by the file system.

When the management file is updated in step S102, the backup file is also updated. The backup information items created in steps S103 and S104 and stored in the non-volatile memory 12a are prepared for each of the property file, thumbnail file, and metadata file as the management file and each of the three backup files corresponding to these files.

FIG. 7 shows a procedure for checking the validity of the management file.

When USB data communications are being carried out between the digital video camera 1 according to this embodiment and an external device via the communication unit 16, it is possible to perform operations on the HDD 14 from the external device by the USB mass storage function. Thus, immediately after the closing of a USB connection, for example, it is possible that an operation such as unintended modification (or deletion) has been performed on the management file during the period of connection so that the management file has become invalid, as shown in FIGS. 5A to 5C. Thus, the checking of the validity of the management file is executed when USB data communication with the external device via the communication unit 16 is closed. Thus, in the process shown in FIG. 7, the closing of USB data communication in step S201 is detected. When the closing of USB data communication has been detected, the process proceeds to step S202.

In step S202, an access is made to a directory entry for managing the management file in the file system management information to read information items used for comparison from the directory entry. Examples of the information items used for comparison are information items of file size and date and time of updating, i.e., information items corresponding to the backup information items in this embodiment among the information items stored in the directory entry.

As described with reference to FIG. 6, the management file herein includes a property file, a thumbnail file, and a metadata file, and also includes backup files for the property file, thumbnail file, and metadata file. Thus, in step S202, for example, information items used for comparison are read from directory entries respectively corresponding to these six files.

Then, in step S203, it is checked whether a management file exists as a result of processing in step S202.

As described earlier, as an example of situation where the management file has become invalid, it is possible to consider a case where the management file has been deleted under the control of a personal computer connected by USB mass storage. In this case, even when the information items used for comparison are read in step S202, since information for managing the management file in the file system information is absent, it is not possible to access a directory entry for managing the management file, so that a read error occurs. When this occurs, the checking in step S203 results in NO. In this case, among the six files included in the management file described earlier, the checking in step S203 results in NO when a read error occurs with at least one of the files.

If the directory entry for managing the management file has been accessed normally to read the information items used for comparison in step S202, it is determined that the management file is properly managed by the file system. Thus, the step S203 results in YES.

When the checking in step S203 has resulted in YES, the process proceeds to step S204. In step S204, the non-volatile memory 12a is accessed to read backup information items.

At the time of completion of step S204, information of file size and date and time of updating, read in step S202 as information items used for comparison, and information of file size and date and time of updating, read in step S204 as backup information items, have been obtained. Thus, in step S205, the file size and date and time of updating in the backup information items are compared with the file size and date and time of updating in the information items used for comparison. Then, in step S206, it is determined whether the information items compared match.

At this time, in step S205, the file size and date and time of updating in the backup information items are compared with the file size and date and time of updating in the information items used for comparison for each of the six files included in the management file. Regarding each of the six files, step S206 results in YES when all the results of comparison match while resulting in NO when one or more results of comparison do not match.

The file size can change when the content of the file is changed, and the date and time of updating changes when the file is updated.

Furthermore, the backup information items (file size and date and time of updating) stored in the non-volatile memory 12a can be considered as information that is updated in accordance with operation involving content files in the system operation of the digital video camera 1. When compared with this, the file system information including the information items used for comparison can be considered as information that is updated in accordance with file operations not recognized by the system operation of the digital video camera 1, for example, when a USB mass storage connection is formed.

Thus, when the checking in step S206 results in YES, it is estimated that the management file has been updated constantly in synchronization with updating of the file system. That is, it is estimated that no operation has been performed on the management file from an external information processing apparatus under, for example, a USB mass storage connection. Thus, the management file in this case is valid with appropriate content in accordance with file operations under the system operation of the digital video camera 1.

Thus, in this case, the management file stored on the HDD 14 is read in step S207. Various subsequent operations involving content files are executed with reference to the content file of the management file read as described above. Since the content of the management file is valid, appropriate operations can be expected.

On the other hand, when the checking in step S206 results in NO, modification or the like has been possibly performed on the management file by a file operation that is executed not under the system operation of the digital video camera 1. In this case, the content of the management file is invalid so that it can be regarded that the validity of the management file has been lost.

Thus, in this case, the process proceeds to step S208, in which the management file is recreated. In this embodiment, the management file can be recreated using the backup file.

Then, in step S209, the management file recreated in step S208 is read.

As will be understood from the description with reference to FIGS. 6 and 7, in this embodiment, backup information items representing file size and date and time of updating of the management file are updated and stored on each operation involving a content file in the system operation of the digital video camera 1. Furthermore, the validity of the management file is checked through comparison between the backup information items and information of file size and date and time of updating on the file system (information used for comparison). The results of the comparison indicate whether the management file is valid or not valid as described earlier.

The backup information items actually include information of file sizes and dates and times of updating of, for example, six files, so that it suffices to execute comparison of data of a size on the order of several ten bytes as a whole. Furthermore, even when the number of content files under management is huge, still, the information of file size and information of date and time of updating of the six files are used to check the validity of the management file.

Thus, when compared with a case where, for example, all the content files stored on the HDD 14 are checked, the processing time for checking the validity of the management file is significantly reduced, and the time taken for activation of the system after closing of data communication via, for example, a USB connection is also reduced accordingly, so that high-speed operation can be achieved. Since the backup information items are stored in the non-volatile memory 12a, an access time for reading the backup information items is considerably shorter compared with a case of accessing the HDD 14. This also contributes to the improvement in the speed of activation described above.

Furthermore, in step S208, the management file is recreated using the backup file. For example, when the backup file is absent, information is collected by accessing all the content files stored on the HDD 14, so that a considerable processing time is taken. In contrast, according to this embodiment, the management file can be recreated through processing such as copying the content of the backup file, so that the processing can be executed in a short period. Since the processing for recreating the management file is included in the process that is executed in response to closing of a USB connection, this also contributes to reduction in the system activation time.

The present invention is not limited to the embodiment described above. For example, although information items that are used to check the validity of the management files are a combination of file size and date and time of updating in the embodiment described above, other combinations with a smaller number or larger number of information items may be used as long as the contents of the information items can change in accordance with updating of files. Furthermore, the manner of management of the management file on the basis of the file system, format and specification of the management file, and so forth are not limited to those described with reference to FIGS. 2 and 3. Furthermore, although content files representing image content, audio content, or the like are managed by the management file in the embodiment described above, the types of files managed by the management file are not particularly limited. For example, it is possible to manage text files on the basis of the management file. Furthermore, depending on the actual application of the device, it is possible that files of a specific type managed by the management file coincide with files of all types managed by the file system (basic file management means). In view of this, the present invention may be applied to various types of apparatuses without limitation to digital video cameras.

It should be understood by those skilled in the art that various modifications, combinations, sub-combinations and alterations may occur depending on design requirements and other factors insofar as they are within the scope of the appended claims or the equivalents thereof.

1. An information processing apparatus, comprising:
basic file management means for managing files stored on a storage medium using basic file management information stored on the storage medium;
specific file management means for managing a file of a specific type, among the files managed by the basic file management means, using specific file management information stored on the storage medium as one of the files managed by the basic file management means;
reference-information management means for storing reference information relating to the specific file management information, the reference information having meanings corresponding to predetermined information items in the basic file management information, the predetermined information items being provided for each of the files, and for updating the reference information in accordance with updating of the specific file management information; and
validity checking means for checking validity of the specific file management information by comparing the stored reference information with information items having meanings corresponding to the reference information relating to the specific file management information in the basic file management information.

2. An information processing method, comprising:
managing files stored on a storage medium using basic file management information stored on the storage medium;
managing a file of a specific type, among the managed files, using specific file management information stored on the storage medium as one of the managed files;
storing reference information relating to the specific file management information, the reference information having meanings corresponding to predetermined information items in the basic file management information, the predetermined information items being provided for each of the files, and updating the reference information in accordance with updating of the specific file management information; and
checking validity of the specific file management information by comparing the stored reference information with information items having meanings corresponding to the reference information relating to the specific file management information in the basic file management information.

3. A program for allowing an information processing apparatus to execute an information processing method, the method comprising:
managing files stored on a storage medium using basic file management information stored on the storage medium;
managing a file of a specific type, among the managed files, using specific file management information stored on the storage medium as one of the managed files;
storing reference information relating to the specific file management information, the reference information having meanings corresponding to predetermined information items in the basic file management information, the predetermined information items being provided for each of the files, and updating the reference information in accordance with updating of the specific file management information; and
checking validity of the specific file management information by comparing the stored reference information with the information items having meanings corresponding to the reference information relating to the specific file management information in the basic file management information.

4. An information processing apparatus, comprising:
a basic file manager configured to manage files stored on a storage medium using basic file management information stored on the storage medium;
a specific file manager configured to manage a file of a specific type, among the files managed by the basic file manager, using specific file management information stored on the storage medium as one of the files managed by the basic file manager;
a reference-information manager configured to store reference information relating to the specific file management information, the reference information having meanings corresponding to predetermined information items in the basic file management information, the predetermined information items being provided for each of the files, and to update the reference information in accordance with updating of the specific file management information; and
a validity checker configured to check validity of the specific file management information by comparing the stored reference information with information items having meanings corresponding to the reference information relating to the specific file management information in the basic file management information.
